(19) United States
(12) Patent Application Publication
(10) Pub. No.: US 2010/0188783 A1
(43) Pub. Date: Jul. 29, 2010

(54) MAGNETIC HEAD, AND DISK APPARATUS HAVING THE SAME

(75) Inventor: Tomoko TAGUCHI, Kunitachi-shi (JP)

Correspondence Address: KNOBBE MARTENS OLSON & BEAR LLP, 2040 MAIN STREET, FOURTEENTH FLOOR, IRVINE, CA, 92614, US

(73) Assignee: KABUSHIKI KAISHA TOSHIBA, Tokyo (JP)

(21) Appl. No.: 12/618,617

(22) Filed: Nov. 13, 2009

(30) Foreign Application Priority Data
Jan. 27, 2009 (JP) 2009-015783

(51) Int. Cl. G11B 5/33

(52) U.S. Cl. 360/319; G9B/5.104

(57) ABSTRACT

According to one embodiment, a magnetic head of a disk apparatus includes a main magnetic pole, a recording coil, a return magnetic pole, and a side shield provided on both sides of the main magnetic pole in the width direction, apart magnetically away from the main magnetic pole. The side shield includes on each side of the main magnetic pole a first shield edge which extends from a leading side end face of the return magnetic pole toward the main magnetic pole and opposes the main magnetic pole in at least a part with a gap smaller than the write gap, and a second shield edge which extends from the first shield edge in a direction opposite to the leading side end face of the return magnetic pole and opposes the main magnetic pole with a gap larger than the write gap.

### CROSS-REFERENCE TO RELATED APPLICATIONS

This application is based upon and claims the benefit of priority from Japanese Patent Application No. 2009-015783, filed Jan. 27, 2009, the entire contents of which are incorporated herein by reference.

### BACKGROUND

1. Field

One embodiment of the present invention relates to a magnetic head for vertical magnetic recording used for a disk apparatus, and a disk apparatus having the magnetic head.

2. Description of the Related Art

A magnetic disk drive as a disk apparatus has a magnetic disk provided in a case, a spindle motor to support and rotate the magnetic disk, a magnetic head to read/write information from/to a magnetic disk, and a carriage assembly to support the magnetic head for movement with respect to the magnetic disk. The carriage assembly has an arm supported movably, and a suspension extending from the arm. The magnetic head is supported at an extended end of the suspension. The magnetic head has a slider fixed to the suspension, and a head module provided in the slider. The head module includes a recording head for writing, and a reproducing head for reading.

Recently, a magnetic head for vertical magnetic recording has been proposed to increase the recording density and capacity of a magnetic disk apparatus, or to decrease the dimensions. As disclosed in Jpn. Pat. Appln. KOKAI Publication No. 2007-272958, for example, in such a magnetic head, a recording head has a main magnetic pole to produce a vertical magnetic field, a return magnetic pole or a write shield magnetic pole, which is provided on the trailing side of the main magnetic pole with a write gap, closing a magnetic path to a magnetic disk, and a coil to cause a magnetic flux to flow to the main magnetic pole. The main magnetic pole is arranged in the state that a part of the main magnetic pole is positioned in a recess formed in the write shield magnetic pole. The magnetic head is moved on a track of the magnetic disk, a recording magnetic field is applied to the magnetic disk from immediately below the magnetic pole, and a record pattern is written perpendicularly to a recording layer of the magnetic disk along a track with the width substantially equal to the width of a write gap of the head.

However, in the magnetic head configured as above, when a record pattern is recorded along a track of the magnetic disk, the recording magnetic field of the main magnetic pole leaks from both sides of the track. Thus, the magnetic field may be applied to other adjacent tracks on the recording layer, and the data in the adjacent tracks may be erased by a blur of record. To prevent such data erasure by the blur of record, it is necessary to increase the distance (track pitch) between adjacent tracks on a recording layer of a magnetic disk. This makes it difficult to increase a track density of the recording layer, and cause a bottleneck in increasing a recording density.

### BRIEF DESCRIPTION OF THE SEVERAL VIEWS OF THE DRAWINGS

A general architecture that implements the various features of the invention will now be described with reference to the drawings. The drawings and the associated descriptions are provided to illustrate embodiments of the invention and not to limit the scope of the invention.

FIG. 1 is an exemplary perspective view of an HDD according to a first embodiment of the invention;

FIG. 2 is an exemplary side view of a magnetic head and a suspension of the HDD;

FIG. 3 is an exemplary magnified sectional view of a head module of the magnetic head;

FIG. 4 is an exemplary perspective view in schematic form depicting a recording head of the magnetic head;

FIG. 5 is an exemplary plan view of the recording head viewed from a side of a disk-facing surface of a slider;

FIG. 6 is an exemplary perspective view in schematic form depicting a recording head of a magnetic head according to a comparative example 1;

FIG. 7 is an exemplary perspective view in schematic form depicting a recording head of a magnetic head according to a comparative example 2;

FIG. 8 is an exemplary graph comparing the recording performance of the recording head of the first embodiment, and the recording heads of the comparative examples 1 and 2;

FIG. 9 is an exemplary plan view of the recording head according to a comparative example 3, viewed from a disk-facing surface of a slider;

FIG. 10 is an exemplary graph comparing the recording performance of the recording head of the first embodiment, and the recording heads of the comparative examples 1, 2 and 3;

FIG. 11 is an exemplary plan view of the recording head according to a comparative example 4, viewed from a disk-facing surface of a slider;

FIG. 12 is an exemplary graph comparing the recording performance of the recording head of the first embodiment, and the recording heads of the comparative examples 1, 2 and 4;

FIG. 13 is an exemplary plan view of the recording head according to a comparative example 5, viewed from a disk-facing surface of a slider;

FIG. 14 is an exemplary graph comparing the recording performance of the recording head of the first embodiment, and the recording heads of the comparative examples 1, 2 and 5;

FIG. 15 is an exemplary plan view of a recording head of a magnetic head according to a second embodiment of the invention, viewed from a side of a disk-facing surface of a slider;

FIG. 16 is an exemplary plan view of a recording head of a magnetic head according to a third embodiment of the invention, viewed from a side of a disk-facing surface of a slider; and

FIG. 17 is an exemplary plan view of a recording head of a magnetic head according to a fourth embodiment of the invention, viewed from a side of a disk-facing surface of a slider.

### DETAILED DESCRIPTION

Various embodiments according to the invention will be described hereinafter with reference to the accompanying drawings. In general, according to an aspect of the invention, there is provided a magnetic head for vertical recording data to a vertical two-layer medium, having a soft magnetic layer, and a recording layer with magnetic anisotrophy in the direction perpendicular to a media surface, the magnetic head comprises: a main magnetic pole including a trailing side end face and a leading side end face opposing the trailing side end face, and configured to apply a recording magnetic field perpendicular to the recording layer; a recording coil configured to excite the main magnetic pole; a return magnetic pole including a leading side end face opposing the trailing side end face of the main magnetic pole with a write gap, and configured to define a closed magnetic path between the return magnetic pole and the soft magnetic layer of the recording medium; and a side shield provided on both sides of the main magnetic pole in the width direction, apart magnetically away from the main magnetic pole. The side shield includes on each side of the main magnetic pole a first shield edge which extends from the leading side end face of the return magnetic pole toward the main magnetic pole and opposes the main magnetic pole in at least a part with a gap smaller than the write gap, and a second shield edge which extends from the first shield edge in a direction opposite to the leading side end face of the return magnetic pole and opposes the main magnetic pole with a gap larger than the write gap.

Detailed description will be given of a first embodiment of the invention, in which a disk apparatus according to the invention is provided as a hard disk drive (HDD), with reference to the accompanying drawings.

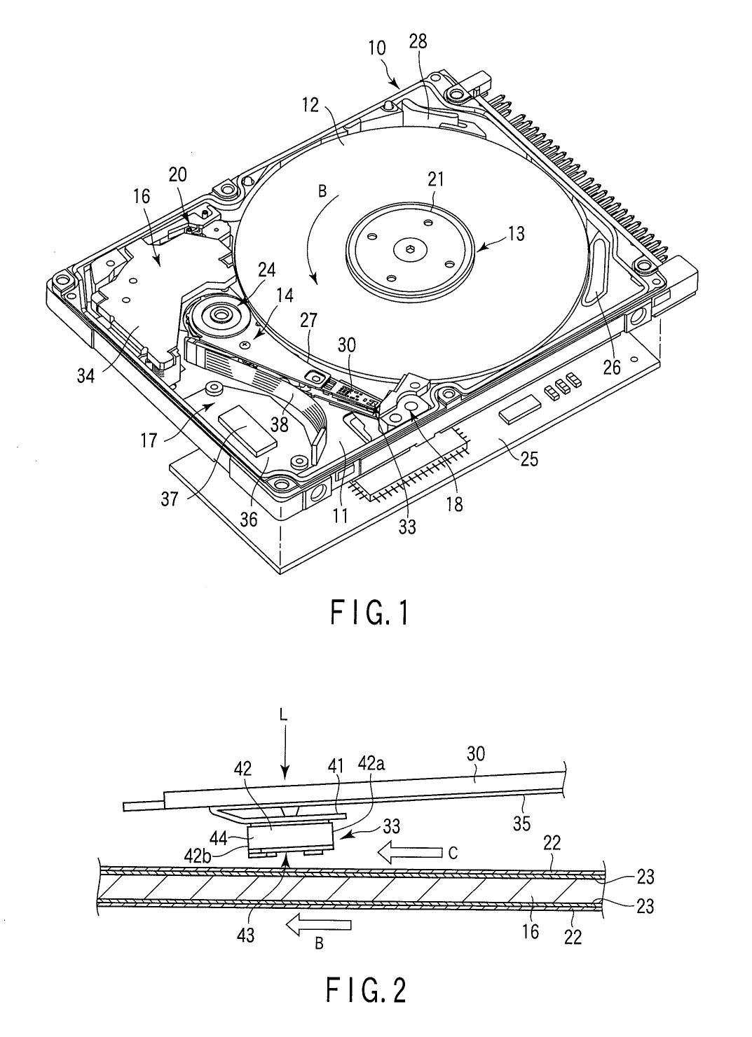

FIG. 1 shows the internal structure of an HDD with a top cover removed. FIG. 2 shows a magnetic head being caused to fly. As shown in FIG. 1, the HDD has a case 10. The case 10 includes a square box-shaped base 11 with an opened top, and a not-shown square plate-shaped top cover. The top cover is fixed to the base with screws, and closes the opened upper side of the base 11. Thus, the interior of the case 10 is kept airtight, and ventilated only through an aspiration filter 26. The base 11 and top cover are made of metallic material, such as aluminum, iron, stainless steel and cold-roll carbon steel plate.

A magnetic disk 12 as a recording medium and a mechanical section are provided on the base 11. The mechanical section includes a spindle motor 13 for supporting and rotating the magnetic disk 12, two or more magnetic heads 33 to record/reproduce information to/from the magnetic disk 12, a head actuator 14 for supporting the magnetic heads 33 movably with respect to the surface of the magnetic disk 12, and a voice coil motor (VCM) to rotate and position the head actuator 14. On the base 11 are further provided a ramp load mechanism 18 which holds the magnetic head 33 at a position isolated from the magnetic disk 12 when the magnetic head 33 is moved to the outermost regions of the magnetic disk 12, an inertia latch mechanism 20 which holds the head actuator 14 at a retreat position when the HDD is subject to a shock, and a substrate unit 17 on which electronic parts such as a preamplifier and a head IC are packaged.

A control circuit board 25, which controls the operations of the spindle motor 13, VCM 16 and magnetic head 33 through the substrate unit 17, is fixed to the outer surface of the base 11 with screws, and opposed to the bottom of the base 11.

As shown in FIGS. 1 and 2, the magnetic disk 12 is constructed as a vertical two-layer film medium. The magnetic disk 12 has a substrate 16 made of nonmagnetic material in the form of a disk of approximate diameter 2.5 inches. A soft magnetic layer 23 called a soft magnetic under-layer is stacked as a foundation layer on both sides of the substrate 16. On the soft magnetic layer 23, a vertical magnetic recording layer 22 with magnetic anisotrophy in the direction perpendicular to the disk surface is sequentially stacked, and a not-shown protective film is formed on the vertical recording layer 22.

As shown in FIG. 1, the magnetic disk 12 is coaxially fit on a hub of the spindle motor 13, and clamped to the hub by a clamp spring 21 screwed to the upper end of the hub. The magnetic disk 12 is rotated by the spindle motor 13 as a drive motor at a predetermined speed in the direction indicated by the arrow B.

The head actuator 14 has a bearing 24 fixed to the bottom of the base 11, and arms 27 extending from the bearing 11. The arms 27 are positioned parallel to the surface of the magnetic disk 12 with predetermined intervals, and extended in the same direction from the bearing 24. The head actuator 14 has a slender, and elastic plate-shaped suspension 30. The suspension 30 consists of a flat spring, and its proximal end is fixed to the distal end of the arm 27 by spot welding or bonding, and is extended from the arm. The suspension 30 may be formed in one body with the arm 27. The magnetic head 33 is supported at the extended end of the suspension 30. The arm 27 and suspension 30 constitute a head suspension. The head suspension and the magnetic head 33 constitute a head suspension assembly.

As shown in FIG. 2, the magnetic head 33 has a substantially rectangular parallelepiped slider 42, and a recording/reproducing head module 44 provided at the outflow end (trailing end) of the slider 42. The magnetic head 33 is fixed to a gimbal spring 41 provided at the distal end portion of the suspension 30. A head load L directing to the surface of the magnetic disk 12 is applied to the magnetic head 33 by the elastic force of the suspension 30. Two arms 27 are positioned parallel with a predetermined interval. The magnetic heads 33 and suspensions 30 fixed to these arms are opposed across the magnetic disk 12.

The magnetic head 33 is electrically connected to a main flexible printed circuit board (main FPC) 38 (described later) through a relay flexible printed circuit board (relay FPC) 35 fixed onto the suspension and arm 27.

As shown in FIG. 1, the substrate unit 17 has an FPC main body 36 formed of a flexible printed circuit board, and a main FPC 38 extending from the FPC main body. The FPC main body 36 is fixed to the bottom of the base 11. On the FPC main body 36, electronic parts including a preamplifier 37 and head IC are mounted. The extended end of the main FPC 38 is connected to the head actuator 14, and connected to the magnetic head 33 through each relay FPC 35.

The VCM 16 has a not-shown support frame extended from the bearing 24 in the direction opposite to the arm 27, and a voice coil supported by the support frame. In the state that the head actuator 14 is mounted on the base 11, the voice coil is positioned between a pair of yokes 34 fixed to the base 11, and constitutes the VCM 16 together with the yokes and magnets fixed to the yokes.

When the magnetic disk 12 is rotated and the voice coil of the VCM 16 is powered, the head actuator 14 is rotated, and the magnetic head 33 is moved and positioned on a desired track of the magnetic disk 12. At this time, the magnetic head 33 is moved between the inner peripheral edge portion and outer peripheral edge portion of the magnetic disk 12, in the radial direction of the magnetic disk.

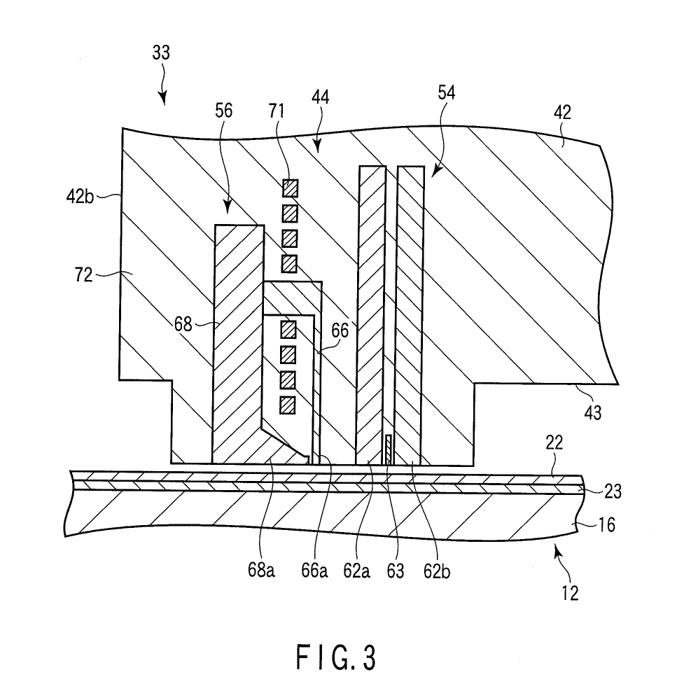

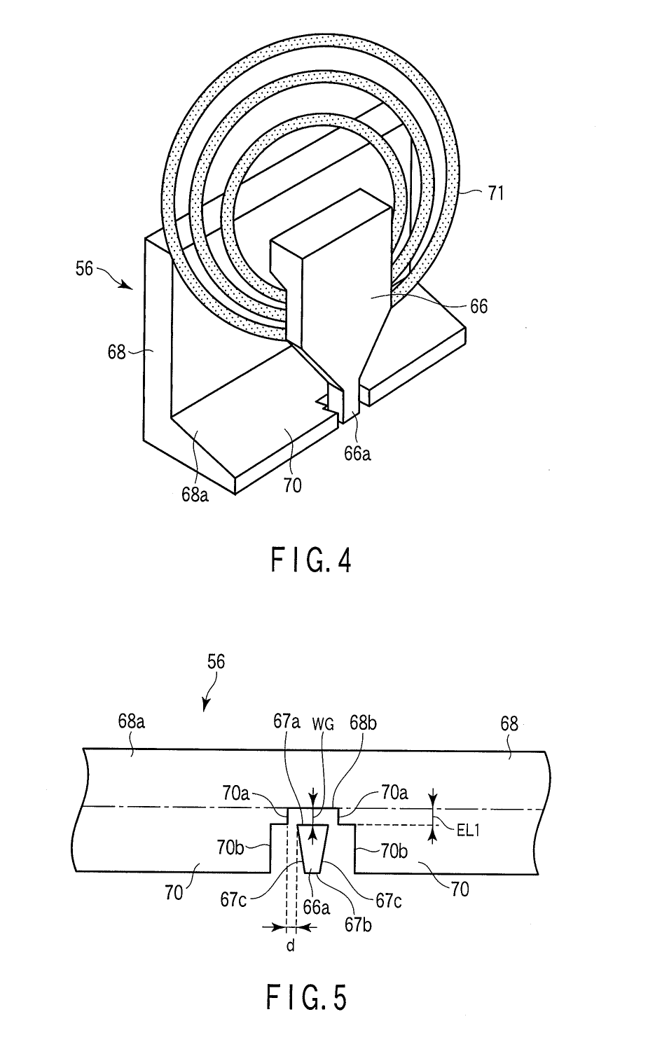

Next, the configuration of the magnetic head 33 will be explained in detail. FIG. 3 is a magnified cross section showing the head module 44 of the magnetic head 33. FIG. 4 is a perspective view schematically showing the recording head of the head module. FIG. 5 shows the recording head viewed from the disk-opposing side of the slider 42.

As shown in FIGS. 2 and 3, the magnetic head 33 is constructed as a flying head, and has a slider 42 in the form of a rectangular parallelepiped, and a head module 44 formed at the outflow end (trailing end) of the slider. The slider 42 is formed of sintered compact (alchik) of alumina and titanium carbide, and the head module 44 is formed of a thin film.

The slider 42 has a rectangular disk-facing surface (air-bearing surface [ABS]) opposing the surface of the magnetic disk 12. The slider 42 is caused to fly by the airflow C produced between the disk surface and disk-facing surface by the rotation of the magnetic disk 12. The direction of the airflow C coincides with the rotating direction B of the magnetic disk 12. The slider 42 is positioned to the surface of the magnetic disk 12, so that the longitudinal direction of the disk-facing surface 43 coincides with the airflow C direction.

The slider 42 has a leading end 42a positioned on the inflow side of the airflow C, and a trailing end 42b positioned on the outflow side of the airflow C. On the disk-facing surface 43 of the slider 42, a not-shown leading step, a trailing step, side steps, and a negative-pressure cavity are provided.

As shown in FIG. 3, the head module 44 is formed as a separated magnetic head, having a reproducing head 54 and a recording head 56 formed by a thin-film process in the trailing end portion 42b of the slider 42.

The reproducing head 54 comprises a magnetic film 63 having a magnetic resistance effect, and shield films 62a and 62b provided on the trailing and leading sides of the magnetic film 63 so that the magnetic film 63 is interposed between the films 62a and 62b. The lower ends of the magnetic film 63, and shield films 62a and 62b are exposed to the disk-facing surface 43 of the slider 42.

The recording head 56 is provided close to the trailing end 42b of the slider 42, with respect to the reproducing head 54. The recording head 56 is constructed as a single-pole head having a return magnetic pole in the trailing end side. As shown in FIGS. 3 and 4, the recording head 56 has a main magnetic pole 66, which is made of high-permeability material, and produces a recording magnetic field in the direction perpendicular to the surface of the magnetic disk 12, a return magnetic pole (write shield electrode) 68, which is positioned on the trailing side of the main magnetic pole 66, and efficiently closes a magnetic path through the soft magnetic layer 23 immediately under the main magnetic pole, and a recording coil 71, which is positioned to wind around a magnetic path including the main magnetic pole 66 and return magnetic pole 68, to cause a magnetic flux to flow to the main magnetic pole 66, when writing a signal to the magnetic disk 12.

As shown in FIGS. 3 to 5, the lower end portion 66a of the main magnetic pole 66 is formed to have a trapezoidal cross section, and has a trailing side end face 67a with a predetermined width positioned on the trailing end side, a leading side end face 67b opposing the trailing side end face 67a and having the width smaller than the trailing side end face 67a, and both side faces 67c. The lower end face of the main magnetic pole 66 is exposed to the disk-facing surface 43 of the slider 42. The width of the trailing side end face 67a substantially corresponds to the width of a track of the magnetic disk 12.

The return magnetic pole 68 is substantially L-shaped, and its lower end portion 68a is shaped like an elongated rectangle. The lower end face of the return magnetic pole 68 is exposed to the disk-facing surface 43 of the slider 42. The leading side end face 68b of the lower end portion 68a extends along the width of a track of the magnetic disk 12. The leading side end face 68b is parallel and opposite to the trailing side end face 67a of the main magnetic pole 66 across a write gap WG.

The recording head 56 has a pair of side shields 70 magnetically divided from the main magnetic pole 66 on the disk-facing surface 43. The side shields 70 are provided on both sides of the main magnetic pole 66 in the length direction of the write gap WG, that is, on both sides in the width direction of a track. The side shields 70 are made of high-permeability material as one body with the lower end portion 68a of the return magnetic pole 68, and extend from the leading side end face 68b of the lower end portion 68a toward the leading end of the slider 42.

As shown in FIG. 5, each side shield 70 has a first shield edge 70a and a second shield edge 70b. The first shield edge 70a extends from the leading side end face 68b of the return magnetic pole 68, and at least a part of the first shield edge 70a opposes the lower end portion 66a of the main magnetic pole 66 with a gap d smaller than the write gap WG. The second shield edge 70b extends from the first shield edge 70a toward the leading end 42a of the slider 42, or extends in the direction opposite to the leading side end face 68b of the return magnetic pole 68. The second shield edge 70b opposes to the main magnetic pole 66 with a gap larger than the write gap WG. The second shield edge 70b is extended to the position with the same level as the leading side end face 67b of the main magnetic pole 66.

In this embodiment, the first shield edge 70a of each side shield 70 extends perpendicular to the leading side end face 68b of the return magnetic pole 68, and the extension height EL1 from the leading side end face 68b is set to the same as the write gap WG. The second shield edge 70b is stepped outward with respect to the first shield edge 70a, and extends perpendicular to the leading side end face 68b.

As shown in FIG. 3, the reproducing head 54 and recording head 56 are covered with a protective insulating film 72 except the parts exposed to the disk-facing surface 43 of the slider 42. The protective insulating film 72 forms a part of the outer shape of the head module 44.

With the HDD configured as described above, when the VCM 16 is driven, the head actuator 14 is rotated, and the magnetic head 33 is moved and positioned on a desired track of the magnetic disk 12. The magnetic head 33 is caused to fly by the airflow C produced by the rotation of the magnetic disk 12 between the disk surface and disk-facing surface 43. When the HDD is driven, the disk-facing surface 43 of the slider 42 opposes the disk surface by keeping a clearance. As shown in FIG. 2, the magnetic head 33 is caused to fly with the recording head 56 of the head module 44 inclined closest to the surface of the magnetic disk 12. In this state, the reproducing head 54 reads the recorded information from the magnetic disk 12, and the recording head 56 writes information to the magnetic disk.

In writing information, the recording coil 71 excites the main magnetic pole 66, and the main magnetic pole applies a vertical recording magnetic field to the recording layer 22 of the magnetic disk 12 located immediately below, thereby recording information in a desired track width. At this time, by providing the side shields 70 on both sides of the main magnetic pole 66 and opposing the first shield edge 70a of the side shield to the main magnetic pole 66 with a gap narrower than the write gap WG, leakage of recording magnetic field from the main magnetic pole 66 to adjacent tracks can be decreased without decreasing the quality of a write signal to be written to a track. Thereby, erasure of records in adjacent tracks can be prevented while keeping the recording capacity in a write track, the track density of the recording layer of the magnetic disk 12 can be increased, and the recording density of the HDD can be increased.

According to the embodiment, there is provided a magnetic head, which is configured to prevent erase of records of adjacent tracts while ensuring a recording capability on a track, and increases a recording density, and a disk apparatus having the magnetic head.

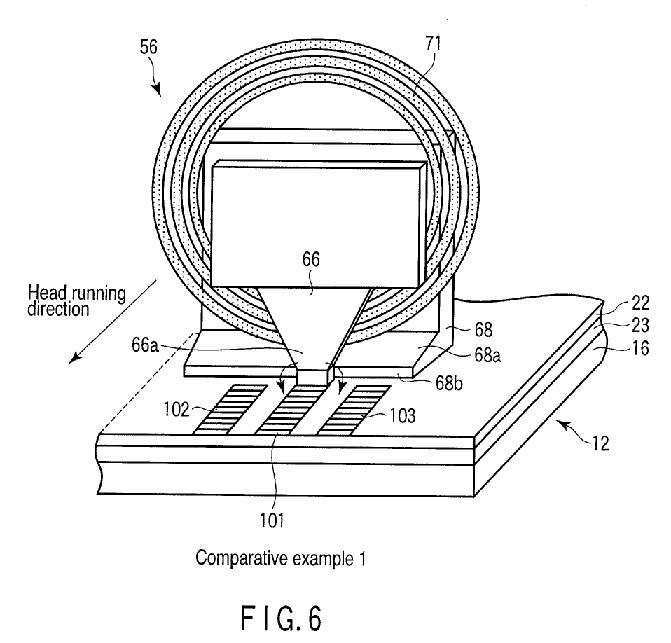

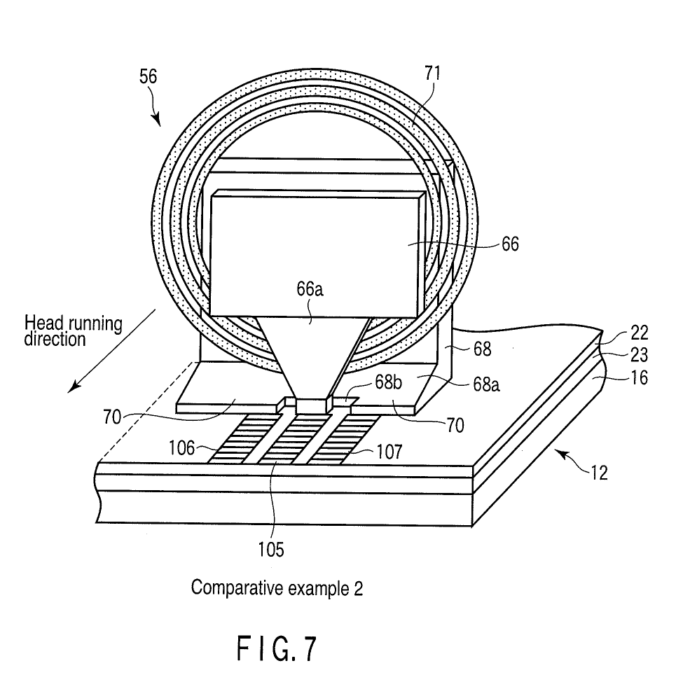

The inventor prepares the magnetic head 33 according to this embodiment, and two or more magnetic heads as comparative examples, and compares the magnetic recording characteristics of these magnetic heads. FIG. 6 is a perspective view of a vertical recording head 56 of a comparative example 1. FIG. 7 is a perspective view of a vertical recording head 56 of a comparative example 2.

As shown in FIG. 6, the recording head 56 of the comparative example 1 comprises a main magnetic pole 66 to produce a vertical magnetic field, a return magnetic pole 68 located on the trailing side of the main magnetic pole 66, and a recording coil 71 to cause a magnetic flux to flow to the main magnetic pole 66. The lower end portion 66a of the main magnetic pole 66 opposes the leading side end face 68b of the return magnetic pole 68 across a write gap WG. Side shields are not provided. The magnetic disk 12 is a vertical two-layer film medium, on which a soft magnetic layer 23 is stacked on the surface of the substrate 16, and a vertical magnetic recording layer 22 with magnetic anisotrophy in the direction perpendicular to the disk surface is stacked on the soft magnetic layer 23.

When the recording head 56 runs on the magnetic disk 12, a recording magnetic field is applied to the disk 12 from immediately below the main magnetic pole 66, and a recording pattern is recorded along a track 101 of the magnetic disk 12. At the same time, the recording magnetic field of the main magnetic pole 66 leaks from both sides of the main magnetic pole 66 in the track width direction, and the leaked magnetic field is applied to the adjacent tracks 102 and 103, erasing the record by a blur of record. In this case, it is necessary to increase the distance (track pitch) from the write track 101 to the adjacent tracks 102 and 103 to prevent the erase by the leakage of magnetic field from the main magnetic pole 66 to the track width direction. This makes it difficult to increase the track density.

As shown in FIG. 7, the recording head 56 of the comparative example 2 comprises a main magnetic pole 66 to produce a vertical magnetic field, a return magnetic pole 68 located on the training side of the main magnetic pole 66, and a recording coil 71 to cause a magnetic flux to flow to the main magnetic pole 66. The lower end portion 66a of the main magnetic pole 66 opposes the leading side end face 68b of the return magnetic pole 68 across a write gap WG. On both sides of the lower end portion 66a of the main magnetic pole 66, a side shield 70 made of high-permeability material is provided and fixed to the return magnetic pole 68. The shield edge of the side shield 70 opposes the main magnetic pole 66 with a gap larger than the write gap WG. The magnetic disk 12 is a vertical two-layer film medium, on which a soft magnetic layer 23 is stacked on the surface of the substrate 16, and a vertical magnetic recording layer 22 with magnetic anisotrophy in the direction perpendicular to the disk surface is stacked on the soft magnetic layer 23.

When the recording head 56 runs on the magnetic disk 12, a recording magnetic field is applied to the disk from immediately below the main magnetic pole 66, and a recording pattern is recorded along a write track 101 of the magnetic disk. At the same time, as the side shields 70 are provided on both sides of the main magnetic pole 66, leakage of a magnetic field to the adjacent tracks 102 and 103 is prevented. However, the side shields 70 weaken the magnetic field applied from immediately below the main magnetic pole 66, the signal quality is degraded. Thus, it is difficult to increase the bit density.

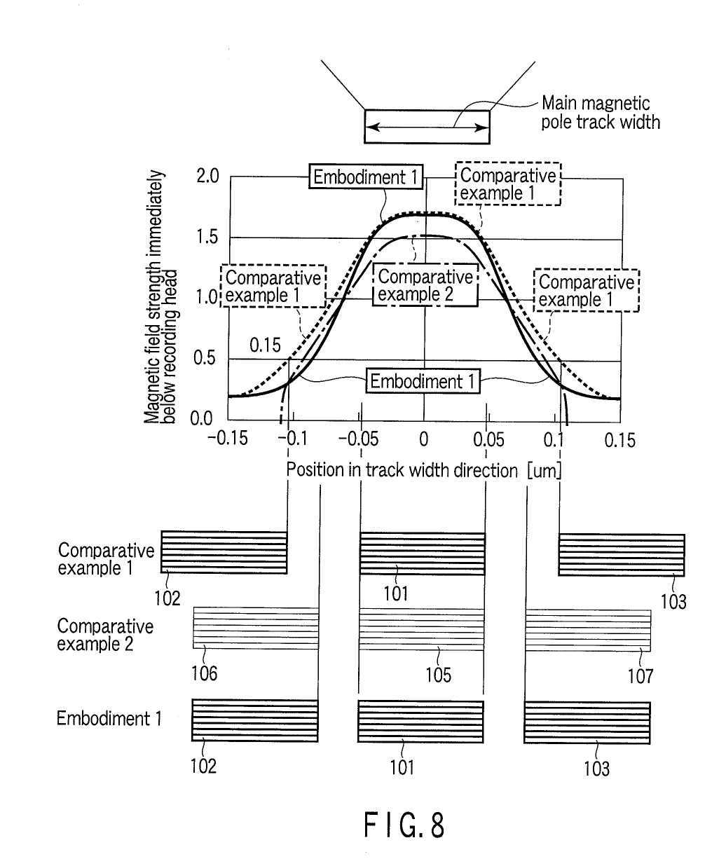

FIG. 8 is a graph comparing the recording performance of the recording head 56 of the first embodiment, and the recording heads of the comparative examples 1 and 2. The graph shows the distribution of the recording magnetic fields from the recording heads in the off-track direction. In each recording head, the track width on the trailing side end face of the main magnetic pole 66 is 80 nm, and the write gap WG is 40 nm. In FIG. 8, the position where the position in the track direction is 0 is the center position in the track width direction of the recording head.

As indicated by a broken line in FIG. 8, in the distribution of the recording magnetic field from the recording head of the comparative example 1 in the off-track direction, leakage of a magnetic field is larger in the outside of the track width direction than in the main magnetic pole track width. As indicated by a dot and dashed line in FIG. 8, in the distribution of the recording magnetic field from the recording head of the comparative example 2 in the off-track direction, leakage of a magnetic field is smaller in the outside of the track width direction than in the main magnetic pole track width, but the magnetic field is reduced at the center of the recording head.

As indicated by a solid line in FIG. 8, in the distribution of the recording magnetic field from the recording head 56 of the first embodiment, the magnetic field at the center of the track width direction is kept equal to that of the recording head of the comparative example 1, and the leakage of the magnetic field from the track width direction of the main magnetic pole 66 is smaller than the leakage of the magnetic field in the comparative examples 1 and 2. According to the comparison, it is seen that a track density can be increased without degrading the on-track recording signal quality by recording with the recording head 56 of the first embodiment.

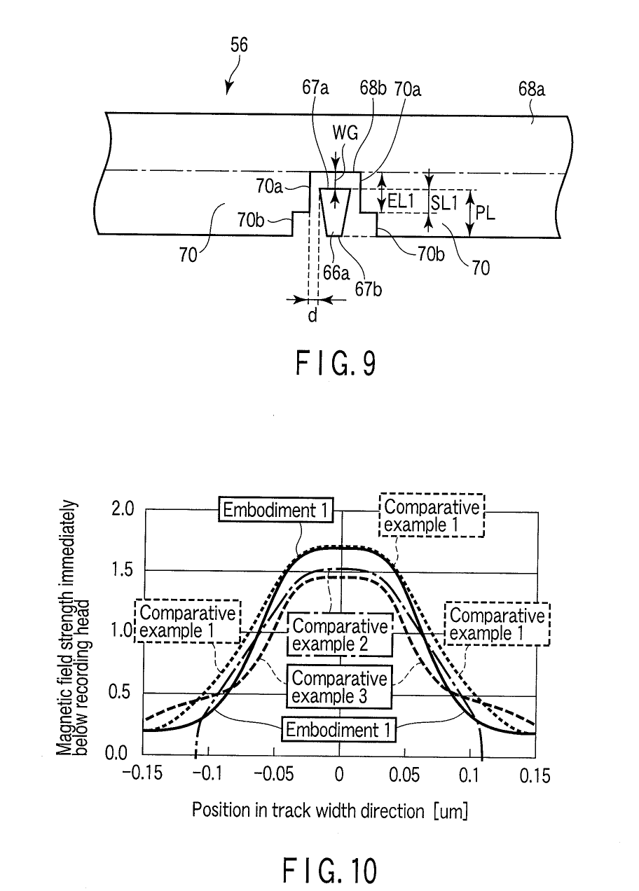

FIG. 9 shows a recording head according to a comparative example 3, viewed from a disk-facing surface of a slider.

In the comparative example 3, a first shield edge 70a of the side shield 70 extends from the leading side end face 68b of the return magnetic pole 66 toward the leading end side, exceeding the trailing side end face 67a of the main magnetic pole 66 only by a distance SL1. The distance SL1 is set to half of the width PL in the thickness direction of the lower end portion 66a of the main magnetic pole 66.

FIG. 10 is a graph comparing the recording performance of the recording head 56 of the first embodiment, and the recording heads of the comparative examples 1, 2 and 3. The graph shows the distribution of the recording magnetic fields from the recording heads in the off-track direction. As indicated by a thick broken line in FIG. 10, the distribution of the recording magnetic field from the recording head 56 of the comparative example 3 is degraded to the level equivalent to that from the recording head of the comparative example 2 at the center of the recording head. This being the case, when the first shield edge 70a of the side shield 70 extends toward the leading end side exceeding the trailing side end face 67a of the main magnetic pole 66, the extension height EL1 of the first shield edge 70a (the distance SL1 from the trailing side end face 67a of the main magnetic pole 66 to the extended end of the first shield edge 70a) is preferably set to smaller than PL/2.

FIG. 11 is a view of a recording head according to a comparative example 4, viewed from a disk-facing surface of a slider. In the comparative example 4, the extension height EL1 of the first shield edge 70a of the side shield 70 is shorter than the write gap WG, and the extended end of the first shield edge 70a is located closer to the leading side end face 68b of the return magnetic pole 68 than the trailing side end face 67a of the main magnetic pole 66 by the distance SL2. The distance SL2 is set to half of the write gap WG.

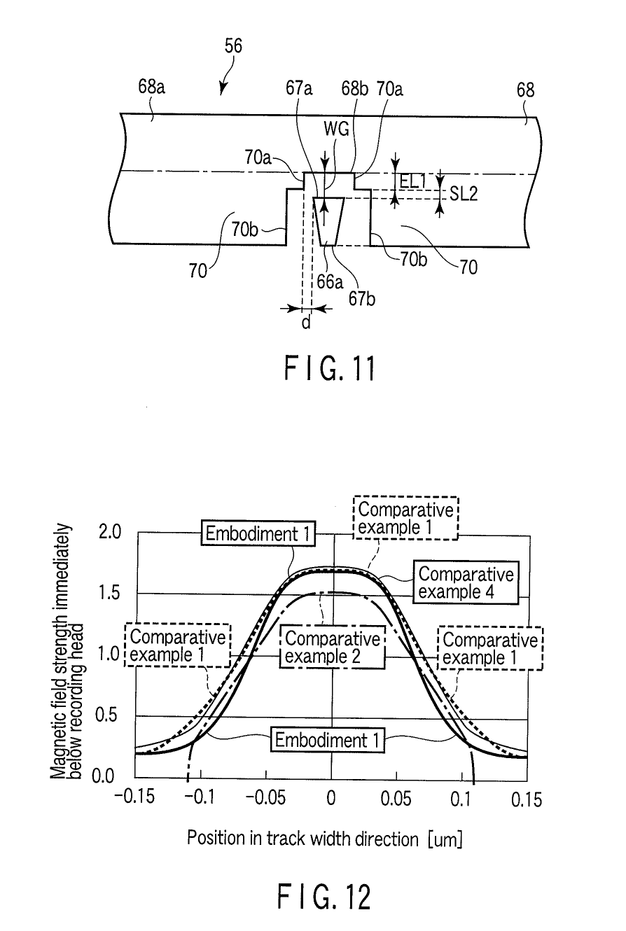

FIG. 12 is a graph comparing the recording performance of the recording head 56 of the first embodiment, and the recording heads of the comparative examples 1, 2 and 4. The graph shows the distribution of the recording magnetic fields from the recording heads in the off-track direction. As indicated by a thin solid line in FIG. 12, the distribution of the recording magnetic field from the recording head 56 of the comparative example 4 is expanded to the outside of the track width direction to the level equivalent to that in the comparative example 1. This being the case, when the first shield edge 70a of the side shield 70 is located closer to the return magnetic pole 68 than the trailing side end face 67a of the main magnetic pole 66, or shorter than the write gap WG, the extension height EL1 of the first shield edge 70a (the distance SL2 from the trailing side end face 67a of the main magnetic pole 66 to the extended end of the first shield edge 70a) is preferably set to smaller than WG/2. In other words, the extension height EL1 of the first shield edge 70a is desirably larger than the write gap WG·1/2.

According to the above, it is seen that the extension height EL1 of the first shield edge 70a of the side shield 70 is set to:

(WG+PL/2)>EL1>WG/2

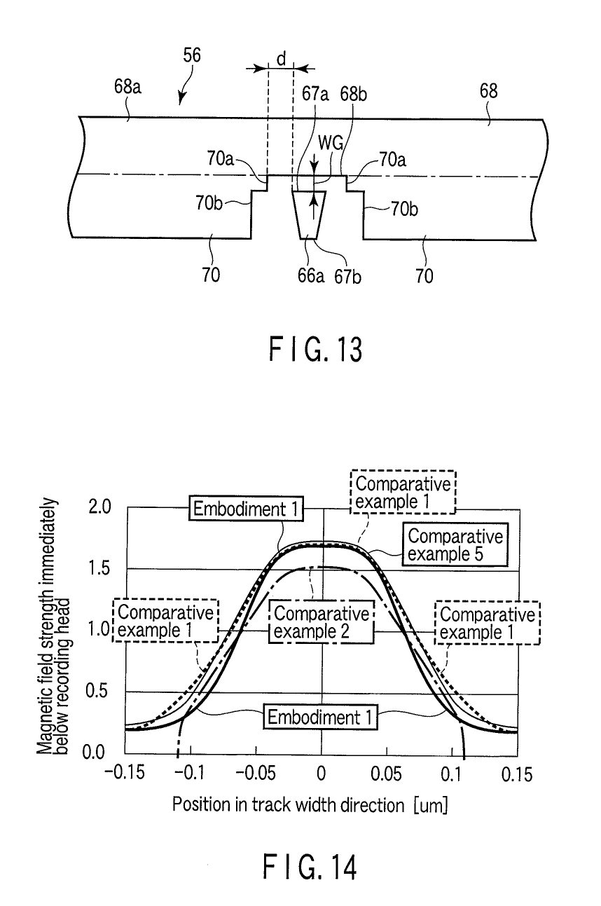

FIG. 13 is a view of a recording head according to a comparative example 5, viewed from a disk-facing surface of a slider. In the comparative example 5, a gap d along the track width direction between the first shield edge 70a of the side shield 70 and the lower end portion 66a of the main magnetic pole 66 is larger than the write gap WG, and is set to larger than the write gap WG by 20%, for example.

FIG. 14 is a graph comparing the recording performance of the recording head 56 of the first embodiment, and the recording heads of the comparative examples 1, 2 and 5. The graph shows the distribution of the recording magnetic fields from the recording heads in the off-track direction. As indicated by a thin solid line in FIG. 14, the distribution of the recording magnetic from the recording head 56 of the comparative example 5 is expanded to the outside of the track width direction to the level equivalent to that in the comparative example 1, when it is set to d=1.2×WG. This being the case, it can be seen that a gap d along the track width direction between the first shield end edge 70a and the lower end portion 66a of the main magnetic pole 66 is desirably smaller than the write gap WG.

Then, an explanation will be given of a magnetic head of a HDD according to a second embodiment of the invention.

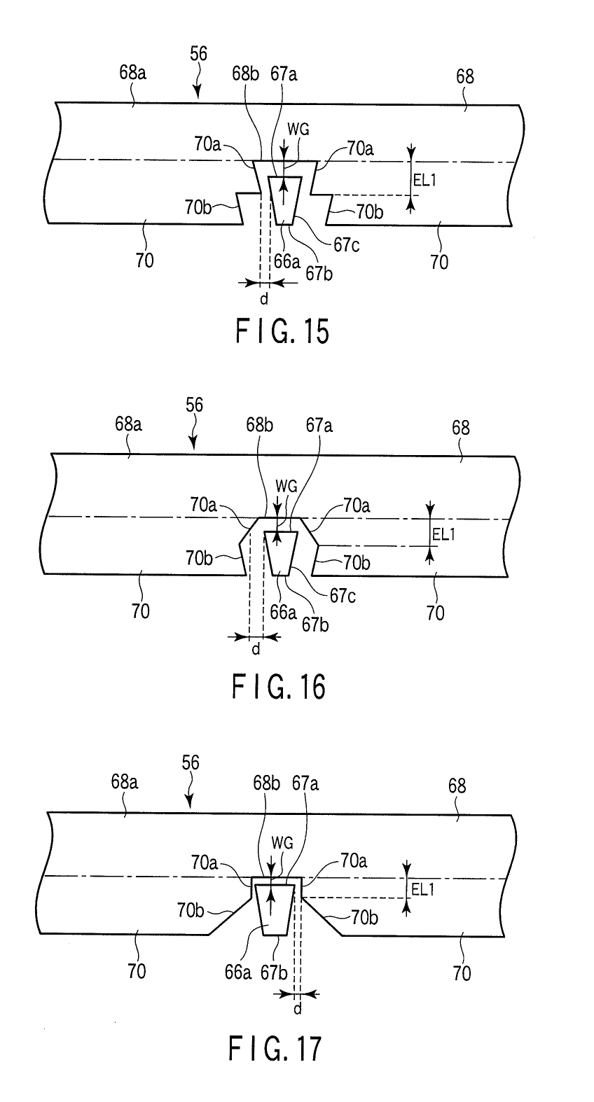

FIG. 15 is a view of a recording head 56 of a magnetic head according to a second embodiment, viewed from a disk-facing surface of a slider. According to the second embodiment, each of side shields 70 provided on both sides of a lower end portion 66a of a main magnetic pole 66 in the track width direction has a first shield edge 70a, which extends from the leading side end face 68b of the return magnetic pole 68, and opposes at least in a part to the lower end portion 66a of the main magnetic pole 66 with a gap d smaller than the write gap WG, and a second shield edge 70b, which extends from the first shield edge 70a toward the leading end 42a of the slider 42, and opposes to the main magnetic pole 66 with a gap larger than the write gap WG. The second shield edge 70b extends to the position with the same level as the leading side end face 67b of the main magnetic pole 66.

In the second embodiment, the first shield edge 70a of the side shield 70 extends from the leading side end face 68b of the return magnetic pole 68 to the leading end, exceeding the trailing side end face 67a of the main magnetic pole 66, and the extension height EL1 is set larger than the write gap WG. The first shield edge 70a inclined to the direction perpendicular to the leading side end face 68b, and extends parallel to the side face of the lower end portion 66a of the main magnetic pole 66. The second shield edge 70b is stepped outward with respect to the first shield edge 70a, and extends parallel to the side face of the lower end portion 66a of the main magnetic pole 66.

Next, an explanation will be given of a magnetic head of a HDD according to a third embodiment of the invention.

FIG. 16 is a view of a recording head 56 of a magnetic head according to a third embodiment, viewed from a disk-facing surface of a slider. According to the third embodiment, each of side shields 70 provided on both sides of a lower end portion 66a of a main magnetic pole 66 in the track width direction has a first shield edge 70a, which extends from the leading side end face 68b of the return magnetic pole 68, and opposes at least in a part to the lower end portion 66a of the main magnetic pole 66 with a gap d smaller than the write gap WG, and a second shield edge 70b, which extends from the first shield edge toward the leading end 42a of the slider 42, and opposes to the main magnetic pole 66 with a gap larger than the write gap WG. The second shield edge 70b extends to the position with the same level as the leading side end face 67b of the main magnetic pole 66.

In the third embodiment, the first shield edge 70a of the side shield 70 extends from the leading side end face 68b of the return magnetic pole 68 toward the leading end, exceeding the trailing side end face 67a of the main magnetic pole 66, and the extension height EL1 is set larger than the write gap WG. The first shield edge 70a extends obliquely to the outside of the direction perpendicular to the leading side end face 68b, or extends obliquely in the direction apart from the lower end portion 66a of the main magnetic pole 66. The second shield edge 70b extends from the end of the first shield edge 70a, parallel to the side face of the lower end portion 66a of the main magnetic pole 66.

Then, an explanation will be given of a magnetic head of a HDD according to a fourth embodiment of the invention.

FIG. 17 is a view of a recording head 56 of a magnetic head according to a fourth embodiment, viewed from a disk-facing surface of a slider. According to the fourth embodiment, each of side shields 70 provided on both sides of the track width direction of a lower end portion 66a of a main magnetic pole 66 has a first shield edge 70a, which extends from the leading side end face 68b of the return magnetic pole 68, and opposes at least in a part to the lower end portion 66a of the main magnetic pole 66 with a gap d smaller than the write gap WG, and a second shield edge 70b, which extends from the first shield edge to the leading end 42a of the slider 42, and opposes to the main magnetic pole 66 with a gap larger than the write gap WG. The second shield edge 70b extends to the position with the same level as the leading side end face 67b of the main magnetic pole 66.

In the fourth embodiment, the first shield edge 70a of the side shield 70 extends from the leading side end face 68b of the return magnetic pole 68 toward the leading end, exceeding the trailing side end face 67a of the main magnetic pole 66, and the extension height EL1 is set larger than the write gap WG. The first shield edge 70a extends in the direction perpendicular to the leading side end face 68b. The second shield edge 70b extends obliquely from the end of the first shield edge 70a, to the outside of the direction perpendicular to the leading side end face 68b, or extends obliquely in the direction apart from the lower end portion 66a of the main magnetic pole 66.

In the above second, third and fourth embodiments, the construction of other parts in the HDD and magnetic head are the same as those in the first embodiment. The same parts are given the same reference numerals, and the detailed explanation thereof is omitted. In the second, third and fourth embodiments, the same function and effect as those of the first embodiment can be obtained.

While certain embodiments of the invention have been described, these embodiments have been presented by way of example only, and are not intended to limit the scope of the invention. Indeed, the novel methods and systems described herein may be embodied in a variety of other forms. Furthermore, various omissions, substitutions and changes in the form of the methods and systems described herein may be made without departing from the spirit of the invention. The accompanying claims and their equivalents are intended to cover such forms or modifications as would fall within the scope and spirit of the invention.

For example, the materials, shapes and sizes of the constituent elements of a head module can be changed if necessary. In the magnetic disk apparatus, the number of magnetic disks and magnetic heads can be increased if necessary, and the size of the magnetic disk is selectable.

What is claimed is:

1. A magnetic head for vertical recording data to a vertical two-layer medium, comprising a soft magnetic layer, and a recording layer with magnetic anisotrophy in a direction perpendicular to a media surface, the magnetic head comprising;
a main magnetic pole comprising a trailing side end face and a leading side end face facing the trailing side end face, and configured to apply a recording magnetic field perpendicular to the recording layer;
a recording coil configured to excite the main magnetic pole;
a return magnetic pole comprising a leading side end face facing the trailing side end face of the main magnetic pole with a write gap, and configured to define a closed magnetic path between the return magnetic pole and the soft magnetic layer of the recording medium; and
a side shield on sides of the main magnetic pole in a width direction, apart magnetically away from the main magnetic pole,
wherein the side shield comprises:
a first shield edge extending from the leading side end face of the return magnetic pole toward the main magnetic pole and facing the main magnetic pole in at least a portion with a gap smaller than the write gap; and
a second shield edge extending from the first shield edge in a direction opposite to the leading side end face of the return magnetic pole and facing the main magnetic pole with a gap larger than the write gap;
wherein the first and second shield edges are on the sides of the main magnetic pole.

2. A magnetic head for vertical recording data to a vertical two-layer medium, comprising a soft magnetic layer, and a recording layer with magnetic anisotrophy in a direction perpendicular to a media surface, the magnetic head comprising:
a slider comprising a surface facing a surface of the recording medium; and
a head module at the slider and configured to write information to the recording medium and to read information from the recording medium,
the head module comprising:
a main magnetic pole comprising a trailing side end face and a leading side end face facing the trailing side end face, and configured to apply a recording magnetic field perpendicular to the recording layer;
a recording coil configured to excite the main magnetic pole;
a return magnetic pole comprising a leading side end face facing the trailing side end face of the main magnetic pole with a write gap, and configured to define a closed magnetic path between the return magnetic pole and the soft magnetic layer of the recording medium; and
a side shield on sides of the main magnetic pole in a width direction, apart magnetically away from the main magnetic pole,
wherein the side shield comprises:
a first shield edge extending from the leading side end face of the return magnetic pole toward the main magnetic pole and facing the main magnetic pole in at least a portion with a gap smaller than the write gap; and
a second shield edge extending from the first shield edge in a direction opposite to the leading side end face of the return magnetic pole and facing the main magnetic pole with a gap larger than the write gap, and
wherein the first and second shield edges are on the sides of the main magnetic pole.

3. The magnetic head of claim 1, wherein an height of an extension of the first shield edge in a direction perpendicular to the leading side end face of the return magnetic pole is larger than half of the write gap.

4. The magnetic head of claim 1, wherein an extension height of the first shield edge in a direction perpendicular to the leading side end face of the return magnetic pole is larger than half of the write gap, and is smaller than the sum of the write gap and half of the width between the trailing side end face and leading side end face of the main magnetic pole.

5. The magnetic head of claim 4, wherein the first and second shield edges are extending perpendicularly to the leading side end face of the return magnetic pole, and a step is between the first and second shield edges.

6. The magnetic head of claim 4, wherein the first and second shield edges are tilted to a direction perpendicular to the leading side end face of the return magnetic pole in the magnetic pole side, and a step is between the first and second shield edges.

7. The magnetic head of claim 4, wherein the first shield edge are tilted to a direction perpendicular to the leading side end face of the return magnetic pole in the outside of the magnetic pole side, and the second shield edge are tilted to a direction perpendicular to the leading side end face of the return magnetic pole toward the main magnetic pole.

8. The magnetic head of claim 4, wherein the first shield edge is extending perpendicularly to the leading side end face of the return magnetic pole, and the second shield edge is tilted to a direction perpendicular to the leading side end face of the return magnetic pole in the outside of the main magnetic pole.

9. The magnetic head of claim 5, wherein the second shield edge is extending to the same level as the leading side end face of the main magnetic pole.

10. A disk apparatus comprising:
a recording medium comprising a soft magnetic layer, and a recording layer with magnetic anisotrophy in a direction perpendicular to a media surface,
a driver configured to support and rotate the recording medium;
a magnetic head comprising a slider comprising a surface facing a surface of the recording medium, and a head at a first end portion of the slider and configured to write information to the recording medium and to read information from the recording medium; and
a head suspension configured to support the magnetic head to move with respect to the recording medium,
the head module comprising:
a main magnetic pole comprising a trailing side end face and a leading side end face facing the trailing side end face, and configured to apply a recording magnetic field perpendicular to the recording layer;
a recording coil configured to excite the main magnetic pole;
a return magnetic pole comprising a leading side end face facing the trailing side end face of the main magnetic pole with a write gap, and configured to define a closed magnetic path between the return magnetic pole and the soft magnetic layer of the recording medium; and
a side shield on sides of the main magnetic pole in a width direction, apart magnetically away from the main magnetic pole,
wherein the side shield comprises:
a first shield edge extending from the leading side end face of the return magnetic pole toward the main magnetic pole and facing the main magnetic pole in at least a portion with a gap smaller than the write gap; and
a second shield edge extending from the first shield edge in a direction opposite to the leading side end face of the return magnetic pole and facing the main magnetic pole with a gap larger than the write gap, and
wherein the first and second shield edges are on the sides of the main magnetic pole.

11. The disk apparatus of claim 10, wherein an height of an extension of the first shield edge in a direction perpendicular to the leading side end face of the return magnetic pole is larger than half of the write gap, and is smaller than the sum of the write gap and half of the width between the trailing side end face and leading side end face of the main magnetic pole.
